(19) United States
(12) Patent Application Publication
(10) Pub. No.: US 2026/0113619 A1
(43) Pub. Date: Apr. 23, 2026

(54) STORING ASSIGNED NETWORK NAMES USING OVER-THE-AIR (OTA) COMMUNICATION

(71) Applicant: T-Mobile USA, Inc., Bellevue, WA (US)

(72) Inventors: Kyeong Hun An, Sammamish, WA (US); Amit Shantanu Deshmukh, Sammamish, WA (US); Nilesh Ranjan, Sammamish, WA (US)

(21) Appl. No.: 18/920,832

(22) Filed: Oct. 18, 2024

(51) Int. Cl. H04W 8/18; H04W 8/08; H04W 84/04

(52) U.S. Cl. CPC H04W 8/183; H04W 8/08; H04W 84/042

(57) ABSTRACT

The present technology relates to storing assigned network names using OTA communication. A wireless device receives a PLMN code of a wireless network to which it is connected. Upon receiving the PLMN code, the device provides the PLMN code to an OTA platform operated by an MNO to which the device is subscribed. The OTA platform can use the received PLMN code to search for an assigned network name associated with the received PLMN code and transmit it to the wireless device. The device then stores the assigned network name at a specific location in a PNN list on a UICC of the device and stores the PLMN code and an indication of the specific location in an OPL on the UICC of the device. The device can then reference the OPL and PNN list to determine and display the assigned network name when connected to the wireless network.

### BACKGROUND

The Public Land Mobile Network (PLMN) network name (PNN) list and the operator PLMN list (OPL) are used to display an assigned name of a wireless network on a wireless device when that device is connected to the network. OTA updates are a crucial mechanism for maintaining and updating the PNN list and the OPL on a physical or embedded subscriber identity module (SIM) of a mobile device. These updates are typically managed by the mobile network operators (MNOs) and are delivered wirelessly to ensure that the device's network information is current and accurate. The process begins with the MNO preparing the necessary update files, which include the latest PNN and OPL data. These files are then transmitted to mobile devices that, in turn, apply the update, refreshing the PNN lists and OPLs to reflect the latest network configurations and operator information. This seamless and automated process ensures that users have access to the most up-to-date network names without requiring manual intervention.

### BRIEF DESCRIPTION OF THE DRAWINGS

Detailed descriptions of implementations of the present invention will be described and explained through the use of the accompanying drawings.

FIG. 1 illustrates a wireless communications network that can implement aspects of the present technology.

FIG. 2 illustrates 5G core network functions (NFs) that can implement aspects of the present technology.

FIG. 3 illustrates an example operating environment in which one or more aspects of the present technology can be implemented.

FIG. 4 illustrates a method for storing assigned network names from OTA communication in accordance with aspects of the present technology.

FIG. 5 illustrates components of a computing device that can implement aspects of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

SIMs include a PNN list and an OPL (e.g., OPL5G) used to enable recognizable identifiers for the networks that the devices are accessing to be displayed on screen. These identifiers can be provided by an MNO of the wireless devices and displayed in place of default network names transmitted from the networks themselves. In many cases, display of these default network names may be suboptimal because the MNO of the wireless devices would like to identify the network in a way related to the user specifically, for example, by identifying a network as a roaming network. The PNN list stores and manages the names of various PLMNs that a mobile device can connect to. The OPL stores these PLMNs and an indication of where in the PNN list the network names assigned to these PLMNs are stored in the PNN list (e.g., a pointer). Thus, working together and in response to receiving the PLMN code of a connected network, the OPL can be used to find, in the PNN list, a network name assigned to a PLMN code in the OPL and display the name on the device, thereby ensuring that users can easily identify their home network as well as any visited networks when roaming.

When a user is provided access to a new network or when an MNO wishes to change the name of an already accessible network, the MNO can send an OTA update to adjust the assigned name at a designated location in the PNN list of a mobile device to which the MNO wishes to make the wireless network available. For example, in response to a new roaming agreement that adds a possible roaming network for a group of wireless devices, the MNO can send an OTA update to the group of wireless devices to cause them to update their OPL with the PLMN code of the network and their PNN list with the assigned name of the network. Similarly, if the MNO wishes to update the name of an existing network, the OTA update can replace a current assigned name of the network in these PNN lists with a new assigned name. In general, however, these OTA updates may result in updates to wireless devices that never access the network to which the OTA updates are directed. Thus, these OTA updates can cause wireless devices to store useless name information related to networks that the devices will never access.

Storage space within PNN lists and OPLs is often limited. For example, a PNN list and OPL may be located on a universal integrated circuit card (UICC) of a wireless device that has limited space. Thus, requiring a wireless device to store useless name information related to a network that the device will never access may cause the PNN list or OPL of the device to exceed a desired size for no added benefit. This may require the wireless device to have a larger UICC, which can increase device cost and, in the case of embedded UICC (eUICC) applications, increase the download time for the eUICC profile.

In cases where the size of the PNN list and OPL is capped, causing the wireless device to store this information can cause the device to erase useful name information about a network that the wireless device is likely to access (e.g., a roaming network within a region adjacent to the wireless device). Then, when the wireless device accesses the networks whose names have been erased, the wireless device may not be able to determine an assigned network name and instead display a default network name provided by that network. As discussed above, these default network names may provide users with less information about how a network is related to their service. Accordingly, providing OTA updates to a group of devices, whether or not those devices are likely to ever access the networks to which those OTA updates concern, can create inefficiencies and degrade user experience.

To reduce these inefficiencies and prevent degradation of the user experience, a network name application located on the UICC can be used to dynamically receive OTA updates directed only to the wireless devices that have accessed networks to which the updates are related. Specifically, the network name application can determine when a PLMN code received by a wireless device has changed. In response to the change, the network name application can provide the PLMN code to the OTA platform to enable the OTA platform to determine an assigned network name associated with the PLMN code. For example, the OTA platform can use the received PLMN code to query a server on the OTA platform that stores assigned network names associated with respective PLMN codes. The assigned network name associated with the PLMN code can be returned in response to the query.

Once the OTA platform determines the assigned network name associated with the PLMN code, the assigned network name can be transmitted individually to the device that provided the PLMN code to the OTA platform. For example, an OTA update can be transmitted that targets a SIM associated with a user of the wireless device that provided the PLMN code to the OTA platform. In response to the OTA update, the PNN list can be updated with the assigned network name provided in the OTA update and the OPL can be updated with the PLMN code and an indication of where the assigned network name is stored in the PNN list. In this way, when the wireless device searches the OPL using the PLMN code to which it is currently connected, the wireless device will determine the location where the assigned network name associated with that PLMN code is stored in the PNN, retrieve it, and display it to the user on the device.

By receiving the OTA update after receiving the PLMN code from a network, the OTA update can be provided when it is actually needed on the device (e.g., because the device is connected to the network and the user would benefit from knowing the name of the network to which their device is connected). Thus, OTA updates can be provided on an on-demand basis without requiring constant OTA updates pushed to devices that may not even use the information provided in the updates.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

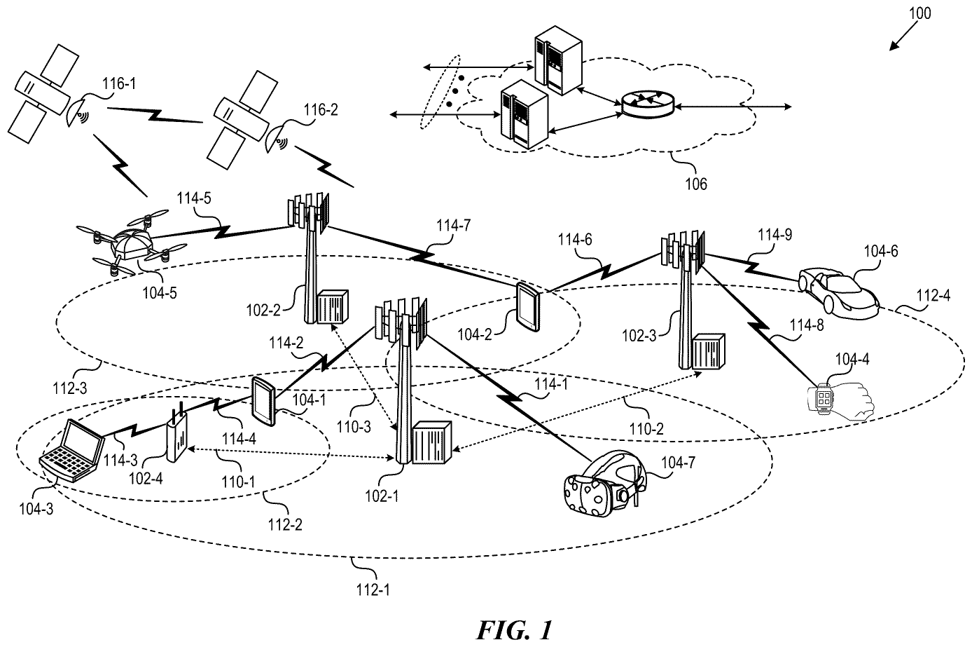

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 (Gigahertz)GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid Automatic Repeat Request (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a UE, a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of the network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, an NTN is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### 5g Core Network Functions

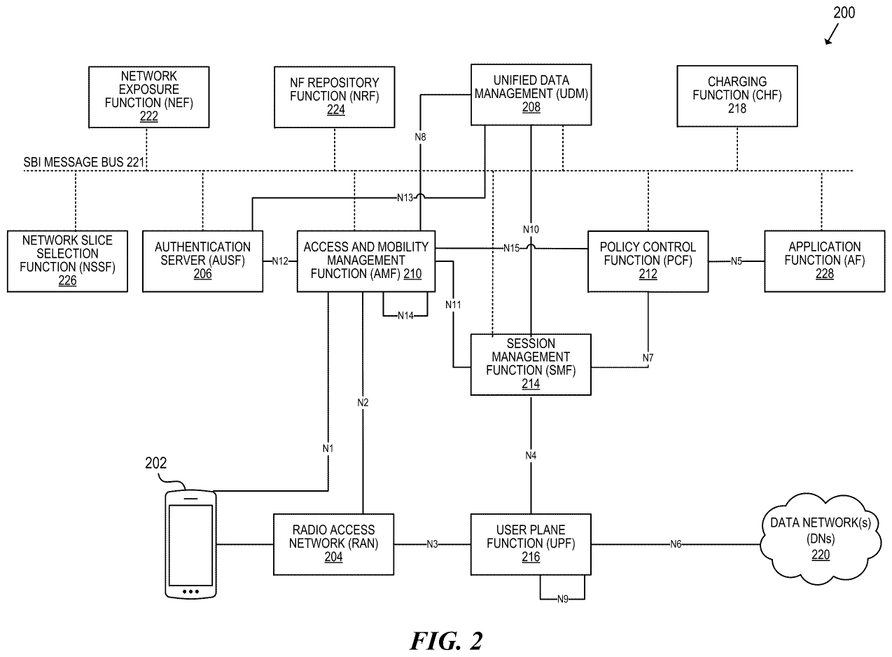

FIG. 2 is a block diagram that illustrates an architecture 200 including 5G core NFs that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility Management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service-Based Architecture (SBA) through a Service-Based Interface (SBI) 221 that uses Hypertext Transfer Protocol 2 (HTTP/2). The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given that a large number of wireless devices can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a data center, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Communicating Assigned Network Names OTA

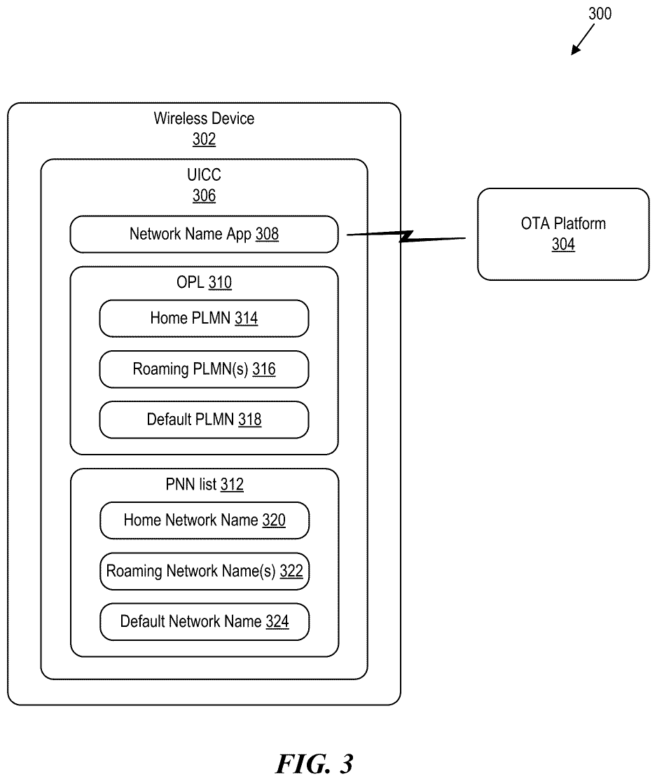

FIG. 3 illustrates an example operating environment 300 in which one or more aspects of the present technology can be implemented. The operating environment 300 includes a wireless device 302 and an OTA platform 304 managed by an MNO to which the wireless device 302 is subscribed. Communications between the wireless device 302 and the OTA platform 304 can be implemented through a wireless network provided by the MNO. In aspects, the communication can be performed through short-message service (SMS). The OTA platform 304 can be implemented on a server hosted by the MNO. In this way, the MNO can send OTA updates using the OTA platform 304 and over the wireless network to communicate information to the wireless device 302. Similarly, the wireless device 302 can communicate with the OTA platform 304 (e.g., directly or indirectly) to receive updated information about the network.

The wireless device 302 includes a UICC 306, which can store user-specific data, including subscriber identity information, authentication credentials, and network-specific information that can be used to communicate on the network. The UICC 306 can further support applications that provide functionality to the wireless device 302. For example, the UICC 306 can implement a SIM that enables a user to communicate on a network using provisioned credentials. In some cases, the UICC 306 can be implemented as an eUICC. In other cases, the UICC 306 can be replaced with a physical SIM card or embedded SIM (eSIM).

One such application that can be supported on the UICC 306 includes a network name application 308. The network name application 308 can manage and store the assigned names of accessible networks at the UICC 306. For example, the network name application 308 can manage data stored in the OPL 310 and the PNN list 312 on the UICC 306. The network name application 308 can receive OTA updates from the OTA platform 304 and make changes to the information stored at the UICC 306 based on the OTA updates. The OTA updates can be provided to a group of subscribers to the MNO in response to a push from the MNO. The network name application 308 can further communicate with the OTA platform 304 on demand to determine if an OTA update is available for the wireless device 302.

The OPL 310 can store information associated with one or more networks to which the wireless device 302 is authorized to communicate. For example, the OPL 310 can store PLMN codes for one or more networks on which the wireless device is authorized to communicate. The wireless device 302 can communicate on a home network provided by the MNO to which they are subscribed and one or more roaming networks that maintain partnership agreements with the home network that allow subscribers of the home network to communicate on the roaming networks. Thus, the OPL can include a home PLMN 314 associated with the home network and one or more roaming PLMNs 316 associated with the various roaming networks on which the wireless device 302 can communicate. As illustrated, the OPL 310 can further include a default PLMN 318 that can be associated with any network that does not match the home PLMN 314 or any of the roaming PLMNs 316. Thus, the default PLMN 318 can be stored as a NULL value, a zero value, or any other value that is used to indicate that the default PLMN 318 is used when a network does not match the home PLMN 314 or the roaming PLMNs 316.

The PNN list 312 can include assigned network names of the wireless networks stored in the OPL 310. The assigned network names can be provisioned by the MNO to replace a name provided to the wireless device 302 when the wireless device 302 connects to the network. For example, an MNO may wish to label a particular network as a roaming network and display this indication to the user. Accordingly, the assigned name for this network stored in the PNN list 312 can be “ROAMING.” When connected to the network, the device can retrieve the name from the PNN list 312 and display the name “ROAMING” instead of a name assigned by the provider of the network (e.g., the name of the provider) on the display. Similarly, the assigned network names can be assigned differently for different users. Thus, the PNN list 312 can be used to display, for each network, names that are relevant to each user or group of users.

Given that the PNN list 312 corresponds to the network information stored in the OPL 310, the PNN list 312 can include the assigned network names of each network stored in the OPL 310. For example, the PNN list 312 includes the home network name 320, which corresponds to an assigned network of the home network provided by the MNO. The PNN list 312 can also include roaming network names 322, which correspond to assigned network names associated with the roaming networks on which the wireless device 302 is authorized to connect. Similarly, the PNN list 312 can include a default network name 324 that can be displayed when a network does not match the home PLMN 314 or the roaming PLMNs 316. The assigned names stored in the PNN list 312 can include names assigned by the MNO to which the wireless device 302 is described, which can vary from the names of those networks provisioned by their respective providers.

The OPL 310 and the PNN list 312 can be further linked such that the OPL 310 stores an indication of the locations, in the PNN list 312, at which the assigned network names associated with the PLMNs stored in the OPL 310 (e.g., pointers) are stored. For example, the home PLMN 314 can be stored with an indication that the home network name 320 is the first entry in the PNN list (e.g., “1” indicating the first entry, “2” indicating the second entry, a memory address, and so on). The roaming PLMNs 316 and the default PLMN 318 can similarly be stored alongside indications at which the associated network names are stored in the PNN list 312.

Thus, to determine the assigned network name associated with a network to which the wireless device 302 connects, the OPL 310 and the PNN list 312 can be accessed. For example, the wireless device 302 can receive a PLMN code of a network to which the wireless device 302 connects. In response to receiving the PLMN code (e.g., when the wireless device 302 first acquires the network), the OPL 310 can be referenced to determine whether the received PLMN code is stored in the OPL 310. If the received PLMN code corresponds to a PLMN code in the OPL 310, the indication at which the assigned name of the network associated with that PLMN code can be retrieved. For example, if the PLMN code corresponds to one of the roaming PLMNs 316, the indication of where the assigned network name of the network associated with that PLMN code is stored can be retrieved from the OPL 310. If the PLMN code does not match a PLMN code stored in the OPL 310, the indication of where the network name associated with the default PLMN 318 is stored can be retrieved.

Using the indication of where the associated network name is stored, the wireless device 302 can access the PNN list 312 at a location that corresponds to the indication. For example, if the received PLMN code corresponds to one of the roaming network names 322 and the indication of the assigned name associated with that PLMN code corresponds to a second entry in the PNN list 312, the wireless device 302 can access the second entry of the PNN list 312 to retrieve the assigned network name associated with that PLMN code (e.g., one of the roaming network names 322). Similarly, the home PLMN 314 and the default PLMN 318 can be stored alongside indications that point to where the home network name 320 and the default network name 324 are stored within the PNN list 312, respectively.

Once the assigned network name associated with a received PLMN code is retrieved from the PNN list 312, the assigned network name can be displayed on the wireless device 302 (e.g., in an upper left corner where network information is displayed). The wireless device 302 can continue to display the assigned network name until the wireless device 302 disconnects from the network.

The MNO may wish to change the assigned network name of one or more networks over time (e.g., in response to changes in relationship with a roaming partner or new services provided by the roaming partner) or add additional networks to the OPL 310 and PNN list 312 (e.g., in response to new roaming agreements with network providers). To enable this, the OTA platform 304 can be used to communicate OTA updates to one or more wireless devices 302 subscribed to the MNO. The OTA updates can be pushed to all subscribers or a group of subscribers (e.g., using SMS). The wireless device 302 can receive the OTA updates and update the OPL 310 and PNN list 312 to store the information contained in the OPL update. For example, if an assigned network name for a network already stored in the OPL 310 and the PNN list 312 is changed by an OTA update, the network name application 308 can replace the previous entry in the OPL 310 and the PNN list 312 associated with the network with the new information provided in the OTA update. Alternatively, the new network entry can be appended to the OPL 310 and the PNN list 312 without replacing the old entry. Similarly, when an entry associated with the network is not already stored in the OPL 310 and PNN list 312, the information can be appended to the existing information in the OPL 310 and the PNN list 312 or replace an entry associated with a different network.

In many systems, OTA platforms send OTA updates to groups of subscribers in response to new network name information that concerns networks to which the groups of subscribers have access. In doing so, the wireless devices associated with these subscribers receive the OTA updates over time and store the network name information provided in the OTA updates. Given that the OTA updates are sent when updated network name information is received regardless of whether or not a wireless device is about to use the updated network name information, the OTA updates can cause the wireless devices to store network information that is not relevant for a network that the device is currently connected to or, perhaps, may ever be connected to. Accordingly, some OTA updates may cause the wireless device to adjust network name information that provides no benefit to the user.

This inefficiency only becomes more problematic considering the spatial constraints placed on OPLs and PNN lists. For example, UICCs can be constrained to reduce cost and device size. Moreover, in the case of eUICCs, constraining UICC size may be important to ensure a quick download of the network profile OTA. Accordingly, to satisfy the spatial constraints placed on OPLs and PNN lists, OTA updates may cause useful information within these lists to be replaced with useless network name information about networks that the device will never access. Alternatively, the wireless devices can continue to append new network information to the lists, increasing the size of the OPLs and the PNN lists. Thus, current techniques for updating network name information using OTA updates can be ineffective for handling the spatial constraints placed on OPLs and PNN lists.

To resolve this deficiency, the network name application 308 allows for on-demand access to the OTA platform 304 when the wireless device 302 connects to a network. Specifically, the network name application 308 can communicate a received PLMN code of a connected network to the OTA platform 304 to determine the most up-to-date network name information associated with the connected network. The OTA platform 304 can then provide the up-to-date network name information to the network name application 308, which can store the information in the OPL 310 and the PNN list 312. In doing so, the need for the OTA platform 304 to push updates of the network name information can be reduced, thereby reducing waste caused by updating wireless devices with network name information that is not associated with the network to which they are accessing or a network they will ever access.

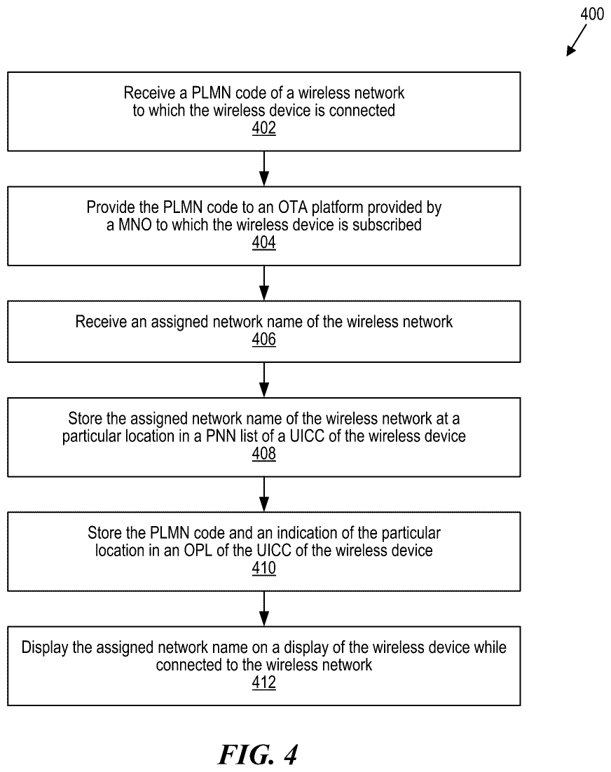

FIG. 4 illustrates a method 400 for storing assigned network names from OTA communication in accordance with aspects of the present technology. Although illustrated in a particular configuration, one or more operations of the method 400 may be omitted, repeated, or reorganized. Additionally, the method 400 may include other operations not illustrated in FIG. 4—for example, operations detailed in one or more other methods described herein.

At 402, a PLMN code of a wireless network to which the wireless device is connected is received. The PLMN code can be received as part of an acquisition of the wireless network. For example, when connected to a network, the wireless device can receive a PLMN code from the network. When the wireless device connects to a new network, the PLMN code received by the wireless device can change. The wireless device can detect this change in the PLMN code and begin a process to determine up-to-date network name information associated with the network having the received PLMN code using an OTA platform provided by the MNO to which the wireless device is subscribed.

In aspects, the wireless device can determine whether or not the PLMN code corresponds to a home network and only attempt to determine on-demand network name information when the PLMN code corresponds to a network other than the home network (e.g., a roaming network). This determination may be helpful because network name updates related to the home network are likely relevant to all subscribers of the MNO and can thus be communicated efficiently using a broad push of the OTA update from the OTA platform.

At 404, the received PLMN code is provided to the OTA platform. In aspects, the PLMN code can be provided to the OTA platform in response to determining that the PLMN code has changed (e.g., due to a connection to a new network) or in response to determining that the connected network is not the home network. In other OTA communications, the wireless device may not provide PLMN information to the OTA platform because the OTA platform is responsible for pushing updates of the network name information to subscribers. In this case, however, the targeted OTA updates can be used to communicate information relevant to a particular subscriber and about a specific network to which the subscriber is connected. Thus, the wireless device can communicate the PLMN code of a connected network to the OTA platform to enable the OTA platform to search for the up-to-date network name information associated with that PLMN code. For example, the OTA platform can query a database storing network name information using the PLMN code to determine up-to-date network name information associated with the PLMN code.

At 406, the assigned network name of the wireless network is received at the wireless device. For example, the assigned network name can be retrieved by the OTA platform from a server storing up-to-date network name information. The assigned network name can be assigned by the MNO and vary from a network name assigned to the connected network by the provider of that network. Moreover, in some cases, the assigned network name can vary based on the user requesting the network name information (e.g., based on a subscription of the user). Once determined by the OTA platform, the assigned network name information can be transmitted OTA to the wireless device that provided the PLMN code used to search for the assigned network name (e.g., through an OTA update). In contrast to other OTA updates, the communication can be targeted to a specific subscriber or group of subscribers currently connected to the network or likely to connect to the network. Thus, widely transmitted OTA updates that may be irrelevant to many of the users that receive them can be limited.

At 408, the assigned network name received from the OTA platform is stored at a particular location in a PNN list of the wireless device. In aspects, the assigned network name can replace a previous assigned network name associated with the same network and entered in the PNN list. In other cases, for example, when no previous assigned network name of the network is stored in the PNN list, the assigned network name can be appended to the PNN list or replace an assigned network name associated with a different network.

At 410, the PLMN code and an indication of the particular location at which the assigned network name associated with the PLMN code is stored in the PNN list (e.g., a pointer) are stored within the OPL. Like with the assigned network name, the PLMN code and the indication of the particular location can replace an entry associated with the PLMN code that was previously stored in the OPL. In cases where the assigned network name replaced a previous entry in the PNN, the PLMN code and pointer directed to the location at which the assigned network name associated with the PLMN code is stored in the PNN can remain accurate for the updated network name. Thus, in these cases, the OPL can remain unchanged in response to the OTA update. In other cases, such as when the location of the assigned network name associated with a particular network is stored in the PNN list changed or when a new network that was not stored in the PNN list is added, an OPL entry can be added to indicate the PLMN code of that particular network and point to the location where the assigned network name of that network is stored in the PNN list.

At 412, the assigned network name is displayed on a display of the wireless device while the device is connected to the wireless network. For example, in response to receiving the PLMN code associated with the network (e.g., as a part of acquisition), the wireless device can access the PNN list and the OPL to determine an assigned network name associated with the wireless network. Specifically, the PLMN code can be used to search the OPL for a corresponding entry and use the pointer associated with the entry to determine where the assigned network name is stored in the PNN list. The wireless device can then access this location to determine the assigned network name and display the assigned network name on the device. For example, the assigned network name can be displayed in a top left corner of the device where network information is displayed (e.g., on a toolbar of the wireless device).

### Computing System

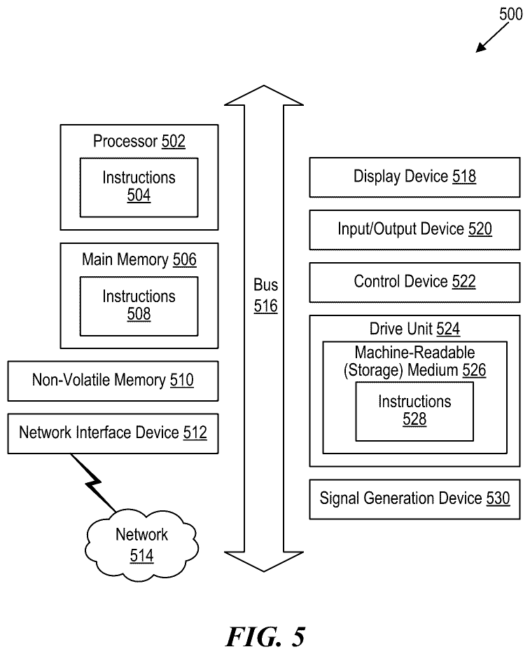

FIG. 5 is a block diagram that illustrates an example of a computing system 500 in which at least some operations described herein can be implemented. As shown, the computing system 500 can include one or more processors 502, main memory 506, non-volatile memory 510, a network interface device 512, a display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computing system 500 is intended to illustrate a hardware device on which components illustrated or described relative to the examples of the figures and any other components described in this specification can be implemented.

The computing system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR system (e.g., head-mounted display), or any electronic device capable of executing a set of instructions that specifies action(s) to be taken by the computing system 500. In some implementations, the computing system 500 can be an embedded computing system, a system-on-chip (SOC), a single-board computing (SBC) system, or a distributed system such as a mesh of computing systems, or it can include one or more cloud components in one or more networks. Where appropriate, one or more computing systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable (storage) medium 526) can be local, remote, or distributed. Although shown as a single medium, the machine-readable (storage) medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable (storage) medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A wireless device comprising:
at least one hardware processor; and
at least one non-transitory memory storing instructions that, when executed by the at least one hardware processor, cause the wireless device to:
receive, at an application located at a universal integrated circuit card (UICC) of the wireless device, a Public Land Mobile Network (PLMN) code of a wireless network to which the wireless device is connected;
in response to receiving the PLMN code from the application, provide the PLMN code to an over-the-air (OTA) platform provided by a mobile network operator to which the wireless device is subscribed;
in response to providing the PLMN code to the OTA platform, receive, from the OTA platform, an assigned network name of the wireless network; and
in response to receiving the assigned network name:
store, at a particular location in a PLMN network name (PNN) list of the wireless device, the assigned network name of the wireless network;
store, in an operator PLMN list (OPL) of the wireless device, the PLMN code and an indication of the particular location in the PNN list; and
display the assigned network name on a display of the wireless device while connected to the wireless network.

2. The wireless device of claim 1, wherein the instructions further cause the wireless device to:
in response to receiving the PLMN code, determine that the PLMN code is associated with a roaming wireless network provided by an additional mobile network operator different from the mobile network operator; and
receive the assigned network name in response to determining that the PLMN code is associated with the roaming wireless network.

3. The wireless device of claim 1, wherein the instructions further cause the wireless device to:
store, at the particular location in the PNN list, the assigned network name of the
wireless network by replacing an existing assigned network name in the PNN list; and
store, in the OPL, the PLMN code and the indication of the particular location in the PNN list by replacing an existing entry stored in the OPL.

4. The wireless device of claim 1, wherein the instructions further cause the wireless device to:
retrieve, from the OPL, the indication of the particular location in the PNN list;
based on the indication of the particular location in the PNN list, retrieve, from the PNN list, the assigned network name at the particular location in the PNN list; and
display the assigned network name on the display of the wireless device while connected to the wireless network in response to retrieving the assigned network name.

5. The wireless device of claim 1, wherein the OPL and the PNN list are located on the UICC of the wireless device.

6. The wireless device of claim 1, wherein the UICC of the wireless device comprises an embedded UICC (eUICC).

7. The wireless device of claim 1, wherein the instructions further cause the wireless device to receive the assigned network name of the wireless network through an OTA update directed to the wireless device alone.

8. The wireless device of claim 1, wherein the instructions further cause the wireless device to:
determine that the PLMN code is different from a previous PLMN code of a previous wireless network to which the wireless device was connected before connecting to the wireless network; and
provide the PLMN code to the OTA platform in response to determining that the PLMN code is different from the previous PLMN code.

9. At least one non-transitory, computer-readable storage medium storing instructions, which, when executed by at least one data processor of a system, cause the system to:
receive a Public Land Mobile Network (PLMN) code of a wireless network to which a wireless device is connected;
in response to receiving the PLMN code, provide the PLMN code to an over-the-air (OTA) platform provided by a mobile network operator to which the wireless device is subscribed;
in response to providing the PLMN code to the OTA platform, receive, from the OTA
platform, an assigned network name of the wireless network; and
in response to receiving the assigned network name:
store, at a particular location in a PLMN network name (PNN) list of the wireless device, the assigned network name of the wireless network; and
store, in an operator PLMN list (OPL) of the wireless device, the PLMN code and an indication of the particular location in the PNN list.

10. The at least one non-transitory, computer-readable storage medium of claim 9, wherein the instructions further cause the system to:
in response to receiving the PLMN code, determine that the PLMN code is associated with a roaming wireless network provided by an additional mobile network operator different from the mobile network operator; and
receive the assigned network name in response to determining that the PLMN code is associated with the roaming wireless network.

11. The at least one non-transitory, computer-readable storage medium of claim 9, wherein the instructions further cause the system to:
store, at the particular location in the PNN list, the assigned network name of the wireless network by replacing an existing assigned network name in the PNN list; and
store, in the OPL, the PLMN code and the indication of the particular location in the PNN list by replacing an existing entry stored in the OPL.

12. The at least one non-transitory, computer-readable storage medium of claim 9, wherein the instructions further cause the system to receive the assigned network name of the wireless network through an OTA update directed to the wireless device alone.

13. The at least one non-transitory, computer-readable storage medium of claim 9, wherein the instructions further cause the system to:
determine that the PLMN code is different from a previous PLMN code of a previous wireless network to which the wireless device was connected before connecting to the wireless network; and
provide the PLMN code to the OTA platform in response to determining that the PLMN code is different from the previous PLMN code.

14. A method comprising:
receiving, at an application located at a universal integrated circuit card (UICC) of a wireless device, a Public Land Mobile Network (PLMN) code of a wireless network to which a wireless device is connected;
in response to receiving the PLMN code, providing the PLMN code to an over-the-air (OTA) platform provided by a mobile network operator to which the wireless device is subscribed;
in response to providing the PLMN code to the OTA platform, receiving, from the OTA platform, an assigned network name of the wireless network; and
in response to receiving the assigned network name, storing, at a particular location in a PLMN network name (PNN) list of the wireless device, the assigned network name of the wireless network.

15. The method of claim 14, further comprising:
in response to receiving the PLMN code, determining that the PLMN code is associated with a roaming wireless network provided by an additional mobile network operator different from the mobile network operator; and
receiving the assigned network name in response to determining that the PLMN code is associated with the roaming wireless network.

16. The method of claim 14, further comprising storing, at the particular location in the PNN list, the assigned network name of the wireless network by replacing an existing assigned network name in the PNN list.

17. The method of claim 14, further comprising:
retrieving, from an operator PLMN list (OPL), an indication of the particular location in the PNN list at which the assigned network name of the wireless network is stored;
based on the indication of the particular location in the PNN list, retrieving, from the PNN list, the assigned network name at the particular location in the PNN list; and
displaying the assigned network name on a display of the wireless device while connected to the wireless network in response to retrieving the assigned network name.

18. The method of claim 14, wherein the PNN list is located on the UICC of the wireless device.

19. The method of claim 14, wherein the UICC of the wireless device comprises an embedded UICC (eUICC).

20. The method of claim 14, further comprising receiving the assigned network name of the wireless network through an OTA update directed to the wireless device alone.
